(19) United States
(12) Patent Application Publication
(10) Pub. No.: US 2012/0280906 A1
(43) Pub. Date: Nov. 8, 2012

(54) Portable Information Processing Device

(75) Inventors: Yasuo Masaki, Daito-shi (JP); Sei Kohno, Daito-shi (JP)

(73) Assignee: Funai Electric Co., Ltd., Daito-shi, Osaka (JP)

(21) Appl. No.: 13/520,647

(22) PCT Filed: Dec. 27, 2010
(86) PCT No.: PCT/JP2010/073567

§ 371 Date: Jul. 5, 2012

(30) Foreign Application Priority Data
Jan. 5, 2010 (JP) 2010-000663

(51) Int. Cl. G06F 3/01

(52) U.S. Cl. 345/156

(57) ABSTRACT

A portable information processing device (1) includes a dedicated return function switch (35) provided on the surface of a housing (20) for returning the portable information processing device to an immediately precedent operation in a remote operation of an apparatus to be controlled in the remote control mode and a shared switch (32, 33) provided on the surface of the housing separately from the dedicated return function switch and sharable in the remote control mode and in the information processing mode.

### TECHNICAL FIELD

The present invention relates to a portable information processing device, and more particularly, it relates to a portable information processing device capable of switch-controlling an information processing mode and a remote control mode.

### BACKGROUND TECHNIQUE

A portable information processing device capable of switch-controlling an information processing mode and a remote control mode is known in general. Such a portable information display terminal is disclosed in Japanese Patent Laying-Open No. 2005-223438, for example.

In the aforementioned Japanese Patent Laying-Open No. 2005-223438, there is disclosed a portable telephone (portable information processing device) including a display portion displaying information, a housing provided with the display portion on a surface and an operation portion, provided on the surface of the housing, on which various buttons for operating the portable telephone are arranged. Further, the portable telephone according to the aforementioned Japanese Patent Laying-Open No. 2005-223438 is formed to be usable as a remote control (remote control mode) of a printer (apparatus to be controlled), in addition to usage as the portable telephone (information processing mode). More specifically, this portable telephone is so formed that the various buttons of the operation portion for operating the portable telephone are switchable to a power supply button, a printing start button and a return button for returning the portable telephone to an immediately precedent operation etc. when used as the remote control of the printer.

### PRIOR ART

### Patent Document

Patent Document 1: Japanese Patent Laying-Open No. 2005-223438

### SUMMARY OF THE INVENTION

### Problems to be Solved by the Invention

In the portable telephone according to the aforementioned Japanese Patent Laying-Open No. 2005-223438, however, the various buttons for operating the portable telephone are switched to the printing start button and the return button for returning the portable telephone to the immediately precedent operation etc. when the portable telephone is used as the remote control of the printer (in the remote control mode), and hence there is such an inconvenience that it is hard for the user to grasp the functions of the various buttons changed in the case of using the portable telephone as the portable telephone and the case of using the portable telephone as the remote control. Therefore, the user must perform a remote control operation while confirming which one of the various buttons is the return button also at a time of entering the return button, relatively frequently used in the remote control, for returning the portable telephone to the immediately precedent operation, for example, and hence there is such a problem that it is troublesome for the user to use the portable information processing device in the remote control mode.

The present invention has been proposed in order to solve the aforementioned problems, and an object of the present invention is to provide a portable information processing device capable of improving convenience at a time of using the portable information processing device in a remote control mode.

### Means for Solving the Problems and Effects of the Invention

A portable information processing device according to an aspect of the present invention includes a display portion displaying information, a housing mounted with the display portion on a surface, a control portion capable of switch-controlling an information processing mode and a remote control mode, a dedicated return function switch provided on the surface of the housing for returning the portable information processing device to an immediately precedent operation in a remote operation of an apparatus to be controlled in the remote control mode and a shared switch provided on the surface of the housing separately from the dedicated return function switch and sharable in the remote control mode and in the information processing mode.

In the portable information processing device according to this aspect, as hereinabove described, the dedicated return function switch for returning the portable information processing device to the immediately precedent operation in the remote control operation of the apparatus to be controlled in the remote control mode is so provided on the surface of the housing that the switch of the return function whose utilization frequency is relatively high in the remote control mode is provided dedicatedly to the return function, whereby the user can easily grasp the position and the function of the dedicated return function switch. Thus, the user can easily enter the dedicated return function switch in a case where he/she wishes to return the portable information processing device to the immediately precedent operation in the remote control operation of the apparatus to be controlled in the remote control mode. Consequently, convenience at the time of using the portable information processing device in the remote control mode can be improved. Further, the shared switch sharable in the remote control mode and in the information processing mode is provided on the surface of the housing separately from the dedicated return function switch, whereby the number of switches provided on the surface of the housing can be reduced as compared with a case of providing all of switches used in the remote control mode separately from switches used in the information processing mode.

Preferably in the portable information processing device according to the aforementioned aspect, the shared switch includes at least one of a selection switch having a function of selecting a selection item both in the remote control mode and in the information processing mode and a decision switch having a function of deciding the selected selection item both in the remote control mode and in the information processing mode. When forming the portable information processing device in this manner, the selection switch and the decision switch have the same functions in the remote control mode and in the information processing mode, whereby the user can easily grasp the position and the function of the shared button including at least one of the selection switch and the decision switch in both cases of the remote control mode and the information processing mode. Thus, the number of switches provided on the surface of the housing can be reduced while improving convenience at the time of using the portable information processing device in the remote control mode.

Preferably, the portable information processing device according to the aforementioned aspect further includes a dedicated information processing mode switch provided on the surface of the housing separately from the dedicated return function switch and the shared switch to be used in the information processing mode. When forming the portable information processing device in this manner, the user can easily grasp the position and the function of the dedicated information processing mode switch in the information processing mode, whereby he/she can easily enter the dedicated information processing mode switch. Consequently, convenience at the time of using the portable information processing device in the information processing mode can be improved.

Preferably, the portable information processing device according to the aforementioned aspect further includes a dedicated changeover switch provided on the surface of the housing separately from the dedicated return function switch and the shared switch for switching the information processing mode and the remote control mode, and the control portion is formed to control the portable information processing device to operate as a remote control on the basis of that the dedicated changeover switch has entered an ON state. When forming the portable information processing device in this manner, the user can immediately switch the portable information processing device to the remote control mode by turning on the dedicated changeover switch in a case where he/she wishes to use the portable information processing device as the remote control, dissimilarly to a case of switching the portable information processing device to the remote control mode by operating a menu screen. Thus, convenience at the time of using the portable information processing device in the remote control mode can be further improved.

Preferably in the portable information processing device according to the aforementioned aspect, the display portion has a touch panel function, and the control portion is formed to control the display portion to display a plurality of remote control operation buttons for performing an operation as a remote control in the remote control mode. When forming the portable information processing device in this manner, the number of switches arranged on the surface of the housing can be reduced, whereby the display portion is so controlled to display the plurality of remote control operation buttons that the portable information processing device can be inhibited from size increase.

Preferably in the portable information processing device including the display portion having the touch panel function, the remote control operation buttons displayed on the display portion include an object apparatus selection button selecting the apparatus to be controlled in the remote control mode and an object apparatus operation button corresponding to the apparatus to be controlled, and the control portion is formed to control the display portion to display the object apparatus operation button corresponding to the selected apparatus to be controlled in a case where the apparatus to be controlled is selected by the object apparatus selection button in the remote control mode. When forming the portable information processing device in this manner, the portable information processing device can be used as a remote control corresponding to a plurality of object apparatuses.

Preferably in the portable information processing device including the display portion having the touch panel function, the control portion is formed to perform control capable of performing a remote control operation with both of the shared switch and the remote control operation buttons also in a case where the remote control operation buttons are displayed on the display portion in the remote control mode. When forming the portable information processing device in this manner, the user can perform the remote control operation by selecting either one of the shared switch and the remote control operation buttons in response to his/her use situation, whereby convenience for the user in the remote control mode can be further improved.

Preferably, the portable information processing device according to the aforementioned aspect further includes a first infrared emission portion capable of emitting infrared rays including a remote control operation signal to a substantially anterior direct front in a state arranging the housing to lay down the housing and the display portion with respect to a placing surface, and a second infrared emission portion capable of emitting infrared rays including the remote control operation signal while inclining the infrared rays by a prescribed angle with respect to the anterior direct front in plan view in the state arranging the housing to lay down the housing and the display portion with respect to the placing surface. When forming the portable information processing device in this manner, the portable information processing device can emit the infrared rays including the remote control operation signal at a wide angle in plan view due to the first infrared emission portion and the second infrared emission portion, whereby an infrared light receiving portion of a television set (apparatus to be remote-controlled) can be made to receive the infrared rays including the remote control operation signal emitted from either one of the first infrared emission portion and the second infrared emission portion also in a case of arranging the housing of the portable information processing device to lay down the housing and the display portion with respect to the placing surface on a position close to the television set having a large-sized screen, for example.

Preferably in the aforementioned portable information processing device capable of emitting the infrared rays including the remote control operation signal, the second infrared emission portion includes a right infrared emission portion capable of emitting the infrared rays including the remote control operation signal while inclining the infrared rays by a first angle rightward with respect to the anterior direct front in plan view and a left infrared emission portion capable of emitting the infrared rays including the remote control operation signal while inclining the infrared rays by a second angle leftward with respect to the substantially anterior direct front in plan view. When forming the portable information processing device in this manner, the portable information processing device can emit the infrared rays including the remote control operation signal in a wide range of the direct front, the right side and the left side respectively due to the first infrared emission portion, the right infrared emission portion and the left infrared emission portion, whereby the infrared light receiving portion of the apparatus to be remote-controlled can be made to easily receive the infrared rays including the remote control operation signal.

Preferably in the aforementioned portable information processing device capable of emitting the infrared rays including the remote control operation signal, a support portion having a larger thickness than a second end portion side is integrally provided on at least a first end portion side on a surface of the housing opposite to the surface provided with the display portion, the support portion is formed to be capable of supporting the housing in a state inclining the housing and the display portion by a prescribed angle with respect to the placing surface in the state laying down the housing and the display portion, and the first infrared emission portion and the second infrared emission portion are provided on the first end portion side of the support portion. When forming the portable information processing device in this manner, the portable information processing device can emit the infrared rays including the remote control operation signal from the first infrared emission portion and the second infrared emission portion toward the front side in the state laying down the housing and the display portion where the housing and the display portion are opposed to the user.

Preferably in the aforementioned portable information processing device capable of emitting the infrared rays including the remote control operation signal, the support portion includes grasp portions provided in the vicinity of both end portions in the longitudinal direction of the housing for manually grasping the housing in a state laterally directing the longitudinal direction of the housing and the display portion, and the portable information processing device further includes a third infrared emission portion capable of emitting the infrared rays including the remote control operation signal while inclining the infrared rays by a third angle obliquely downward or obliquely upward with respect to a direction where the infrared rays including the remote control operation signal are emitted from the first infrared emission portion and the second infrared emission portion from a front end portion of the housing in a state manually grasping the grasp portions so that the longitudinal direction of the housing and the display portion is laterally directed. When forming the portable information processing device in this manner, the third infrared emission portion can emit the infrared rays including the remote control operation signal while inclining the infrared rays by the third angle obliquely downward or obliquely upward also in a case where the user manually grasps the grasp portions so that the longitudinal direction of the housing and the display portion is laterally directed, whereby the infrared light receiving portion of the apparatus to be remote-controlled can be made to receive the infrared rays including the remote control operation signal also in a case where the height positions of the infrared light receiving portion of the apparatus to be remote-controlled and the portable information processing device are different from each other.

Preferably in the aforementioned portable information processing device provided with the support portion capable of supporting the housing, a plurality of projecting portions bringing the housing into point contact with the placing surface in the state laying down the housing and the display portion are provided on the support portion. When forming the portable information processing device in this manner, the housing can be inhibited from backlashing on the placing surface due to the point contact, as compared with a case where the support portion and the placing surface come into surface contact with each other.

Preferably in the portable information processing device according to the aforementioned aspect, the dedicated return function switch and the shared switch are provided on a first side of the display portion on the surface in the longitudinal direction of the housing respectively. When forming the portable information processing device in this manner, the user can easily operate both of the dedicated return function switch and the shared switch with only one hand.

Preferably in this case, the portable information processing device further includes a camera portion provided on a second side of the display portion on the surface in the longitudinal direction of the housing. When forming the portable information processing device in this manner, the hand of the user operating the dedicated return function switch and the shared switch can be inhibited from blocking the field of view of the camera portion when the user operates the dedicated return function switch and the shared switch provided on the first side of the display portion on the surface in the longitudinal direction of the housing.

Preferably, the portable information processing device according to the aforementioned aspect further includes a power supply switch provided on a surface of the housing opposite to the surface provided with the dedicated return function switch and the shared switch. When forming the portable information processing device in this manner, the power supply switch is provided on the surface opposite to the side where the dedicated return function switch and the shared switch frequently operated in use of the device are arranged, whereby the user can be inhibited from erroneously operating the power supply switch in use of the device.

Preferably in the aforementioned portable information processing device including the power supply switch, a support portion having a larger thickness than a second end portion side is integrally provided on at least a first end portion side on a surface of the housing opposite to the surface provided with the display portion, and the power supply switch has a projectional height smaller than the projectional height of the support portion. When forming the portable information processing device in this manner, the power supply switch does not come into contact with the placing surface also in a case of placing the housing on the placing surface in a state grounding the support portion on the placing surface, whereby the power supply switch can be inhibited from being erroneously operated.

Preferably in the aforementioned portable information processing device including the power supply switch, the power supply switch is formed to switch a screen display with respect to the display portion to ON or OFF in a case where the power supply switch is pressed, and formed to switch a main power supply to ON or OFF in a case where the power supply switch is pressed for a time longer than the time for pressing the power supply switch when switching the screen display with respect to the display portion to ON or OFF. When forming the portable information processing device in this manner, the user can perform not only switching of ON or OFF of the main power supply but also switching of ON or OFF of the screen display with respect to the display portion by employing the power supply switch, whereby the number of switches provided on the surface of the housing can be reduced.

Preferably, the portable information processing device according to the aforementioned aspect further includes a sound control switch provided on a surface of the housing opposite to the surface provided with the dedicated return function switch and the shared switch and capable of an operation of controlling the magnitude of an output sound. When forming the portable information processing device in this manner, the sound control switch is provided on the surface opposite to the side where the dedicated return function switch and the shared switch frequently operated in use of the device are arranged, whereby the sound control switch can be inhibited from being erroneously operated by the user in use of the device.

Preferably in the portable information processing device according to the aforementioned aspect, the control portion is formed to perform control of invalidating the dedicated return function switch in the information processing mode. When forming the portable information processing device in this manner, the user can reliably use the dedicated return function switch only in the remote control mode.

### BRIEF DESCRIPTION OF THE DRAWINGS

FIG. 1 A general perspective view for illustrating the structure on a liquid crystal display portion side of a portable information processing device according to an embodiment of the present invention.

FIG. 2 A block diagram for illustrating the internal structure of the portable information processing device shown in FIG. 1.

FIG. 3 A general perspective view for illustrating the structure on a surface side opposite to a surface of a frame of the portable information processing device shown in FIG. 1 provided with the liquid crystal display portion.

FIG. 4 A schematic diagram in plan view for illustrating emission ranges of near infrared LEDs of the portable information processing device shown in FIG. 1.

FIG. 5 A side elevational view in a state laying down the frame and the liquid crystal display portion for illustrating the emission ranges of the near infrared LEDs shown in FIG. 4.

FIG. 6 A side elevational view in a state manually grasping the frame for illustrating the emission ranges of the near infrared LEDs shown in FIG. 4.

FIG. 7 A perspective view showing object apparatus selection buttons displayed on the liquid crystal display portion of the portable information processing device shown in FIG. 1.

FIG. 8 A perspective view showing object apparatus operation buttons displayed on the liquid crystal display portion of the portable information processing device shown in FIG. 1.

FIG. 9 A state transition diagram for illustrating state transition between an information processing mode and a remote control mode of the portable information processing device shown in FIG. 1.

FIG. 10 A perspective view showing a state at a time when the portable information processing device is grasped while laterally directing the longitudinal direction of the portable information processing device shown in FIG. 1.

FIG. 11 A perspective view showing a state at a time when the portable information processing device is grasped while vertically directing the longitudinal direction of the portable information processing device shown in FIG. 1.

FIG. 12 A perspective view showing a front surface side in a state standing up the frame and the liquid crystal display portion of the portable information processing device shown in FIG. 1.

FIG. 13 A perspective view showing a back surface side in the state standing up the frame and the liquid crystal display portion of the portable information processing device shown in FIG. 1.

FIG. 14 A perspective view observing the state laying down the frame and the liquid crystal display portion of the portable information processing device shown in FIG. 1 from a first side portion.

FIG. 15 A perspective view observing the state laying down the frame and the liquid crystal display portion of the portable information processing device shown in FIG. 1 from the front side.

FIG. 16 A perspective view observing the state laying down the frame and the liquid crystal display portion of the portable information processing device shown in FIG. 1 from a second side portion.

FIG. 17 A block diagram showing the internal structure of a portable information processing device according to a modification of this embodiment.

### MODES FOR CARRYING OUT THE INVENTION

An embodiment embodying the present invention is now described on the basis of the drawings.

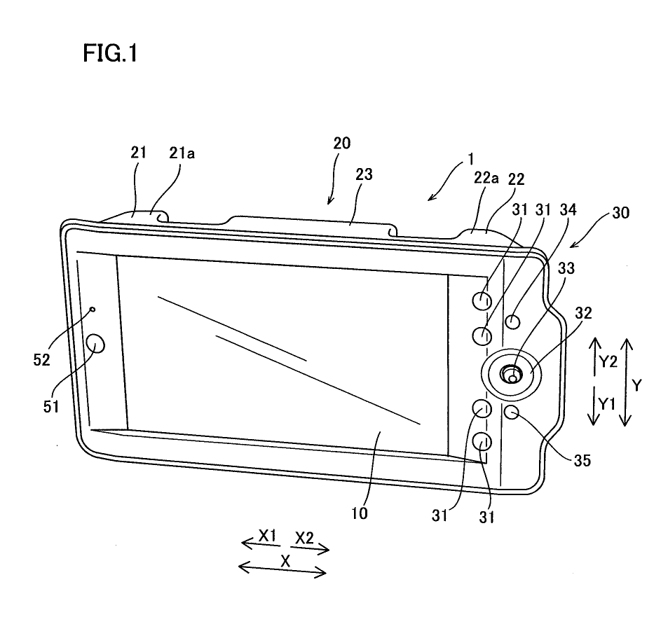

First, the structure of a portable information processing device 1 according to the embodiment of the present invention is described with reference to FIGS. 1 to 8 and FIGS. 10 to 16.

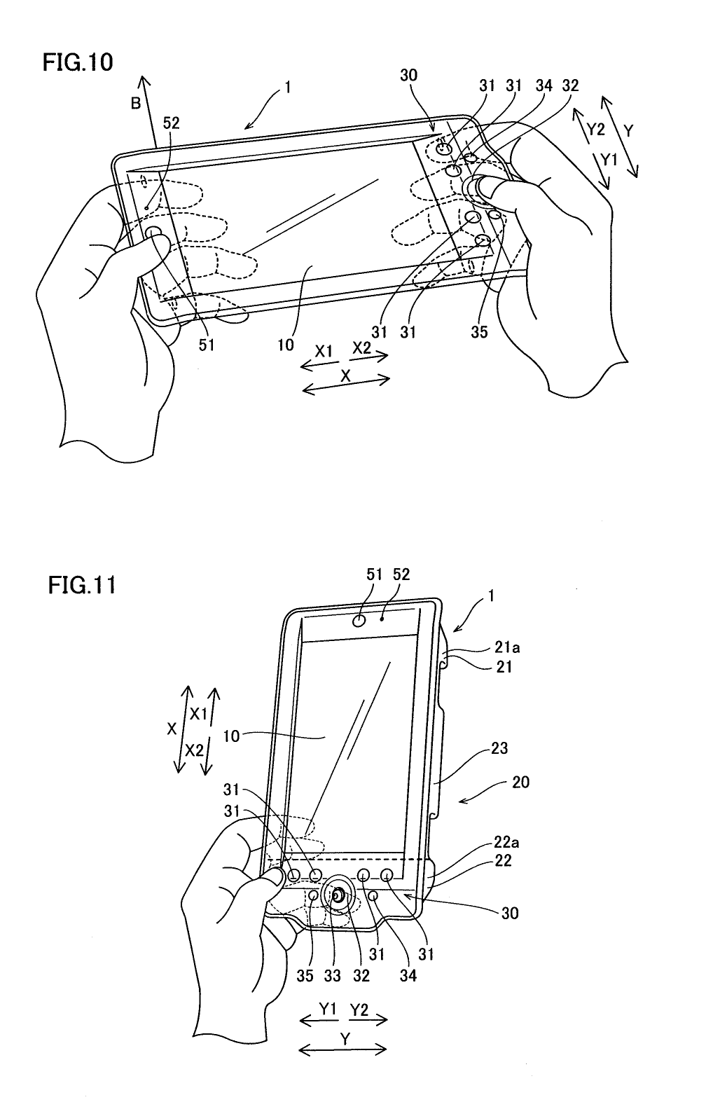

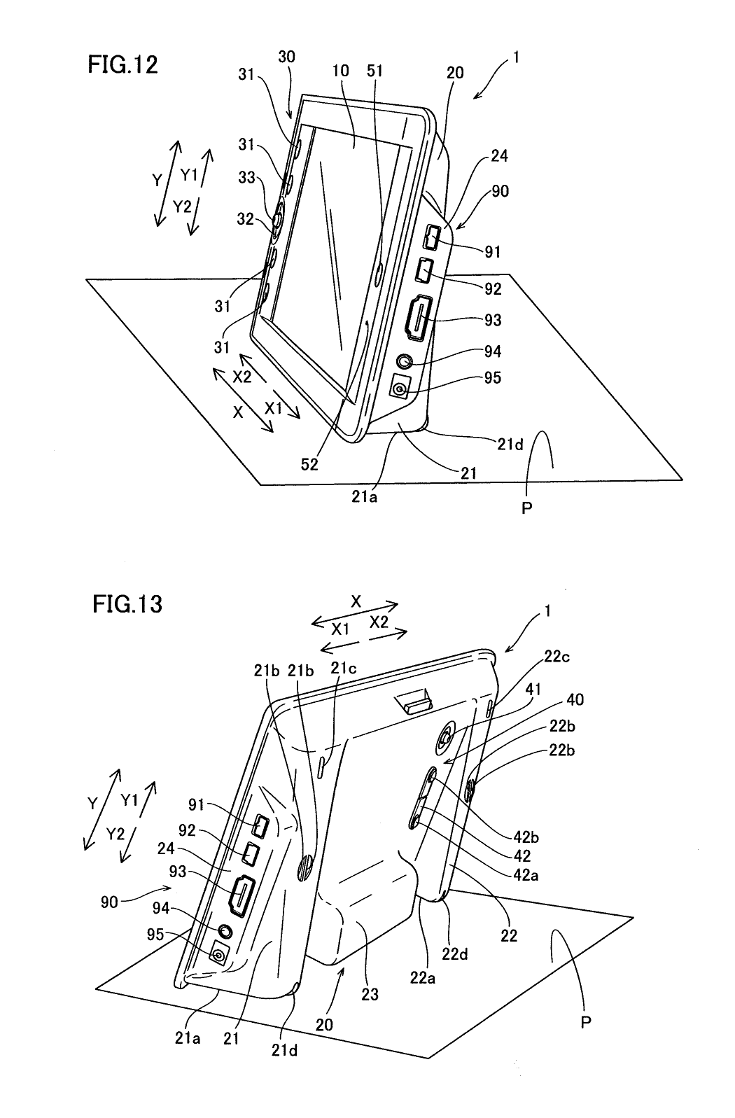

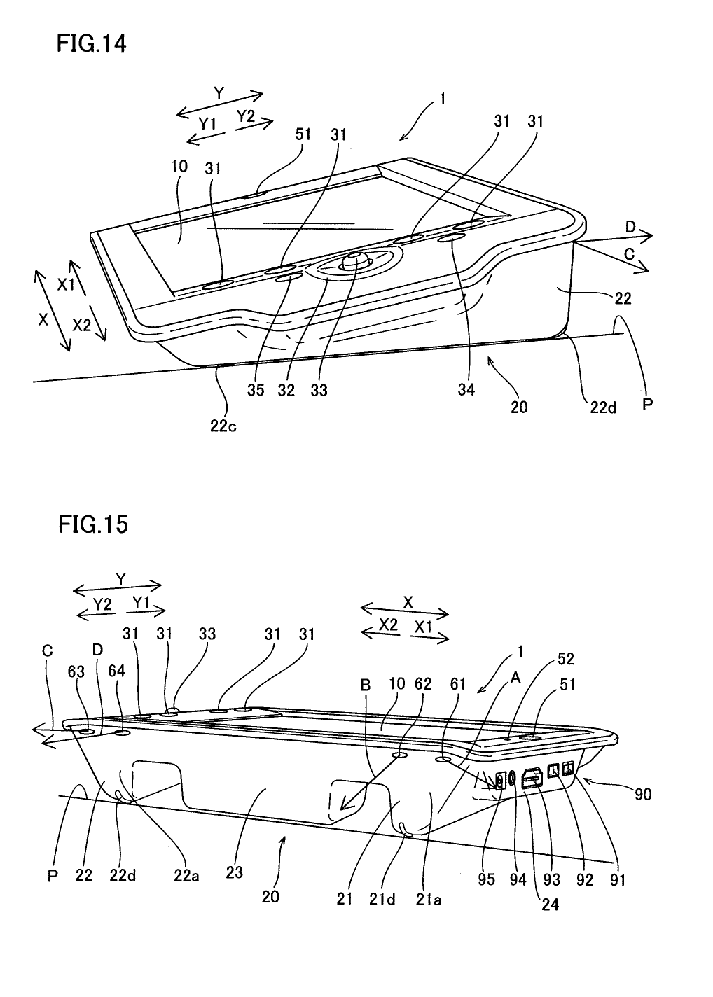

As shown in FIG. 1, the portable information processing device 1 according to the embodiment of the present invention is manly constituted of a liquid crystal display portion 10 displaying information, a frame 20 provided with the liquid crystal display portion 10 on a surface, a front surface-side switch portion 30 provided on a front surface side of the frame 20 and a back surface-side switch portion 40 provided on a back surface (rear surface) side of the frame 20. The liquid crystal display portion 10 is an example of the “display portion” in the present invention, and the frame 20 is an example of the “housing” in the present invention. This portable information processing device 1 is formed to be usable in a state (see FIGS. 10 and 11) grasped by the user described later, and formed to be usable also in a state (see FIGS. 12 and 13) standing up the frame 20 and the liquid crystal display portion 10 and a state (see FIGS. 14 to 16) laying down the frame 20 and the liquid crystal display portion 10.

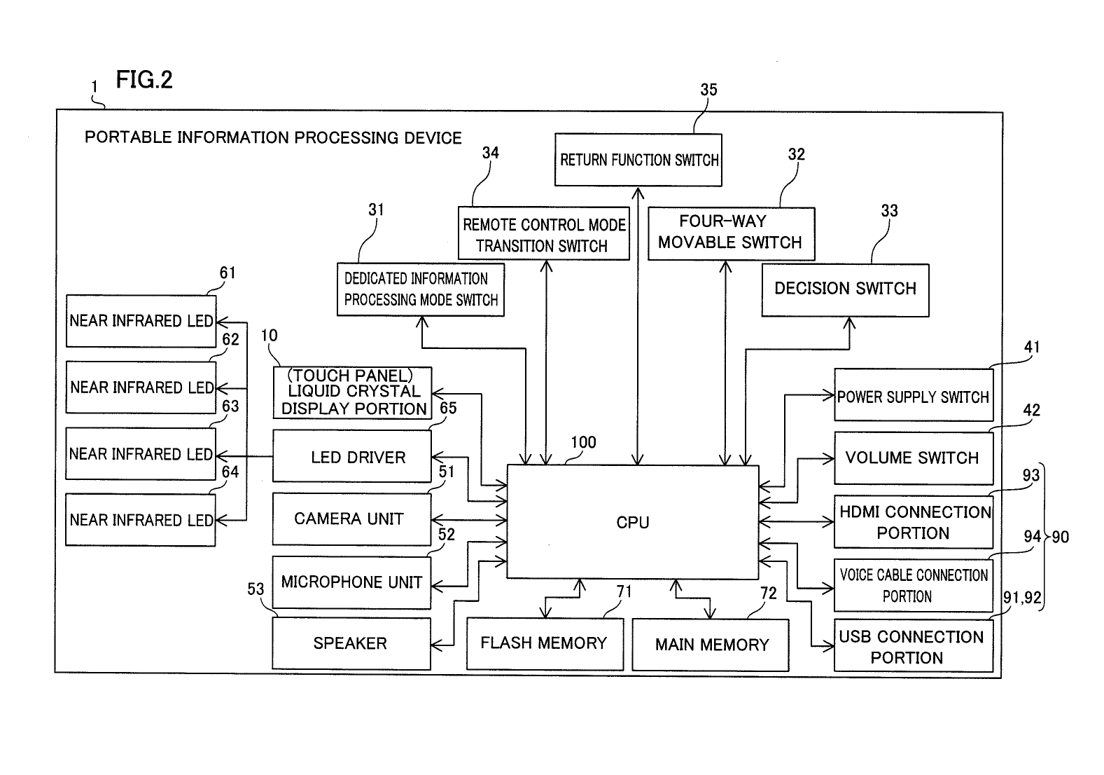

This portable information processing device 1 is formed to be usable not only as the information processing device but also as a remote control of an apparatus (television set or the like) to be controlled. More specifically, the portable information processing device 1 is formed to be connectable to the Internet, and so formed that the user can use an E mail, a video chat, a voice chart and an IP telephone etc. by performing Internet connection in an information processing mode where the same functions as the information processing device. Further, the portable information processing device 1 is formed to function as a remote control of an audio apparatus (not shown) in a remote control mode where the same functions as the remote control of the apparatus (television or the like) to be controlled also in a case where the same is not connected to the Internet. The portable information processing device 1 is so formed that the aforementioned information processing mode and the remote control mode are switch-controllable by a CPU 100 (see FIG. 2) controlling the portable information processing device 1. The CPU 100 is an example of the “control portion” in the present invention. The portable information processing device 1 is usable also as a digital photo frame and a monitor etc. in the state (see FIGS. 12 and 13) standing up the frame 20 and the liquid crystal display portion 10, for example.

The liquid crystal display portion 10 has a touch panel function as shown in FIG. 1, and is so formed that the user is capable of performing an operation according to an application by pressing down operating buttons displayed on the liquid crystal display portion 10. Further, the liquid crystal display portion 10 is connected with the CPU 100 as shown in FIG. 2, and formed to be controlled by the CPU 100. In addition, the liquid crystal display portion 10 is so formed that the direction of display is changeable in response to used states of the portable information display terminal 1 such as the state (state of FIGS. 12 and 13) standing up the frame 20 and the liquid crystal display portion 10, the state (state of FIGS. 14 to 16) laying down the same and the state (state of FIGS. 10 and 11) grasped by the user etc.

According to this embodiment, the front surface-side switch portion 30 includes a plurality of (four) dedicated information processing mode switches 31, a four-way movable switch 32, a decision switch 33, a remote control mode transition switch 34 and a return function switch 35 provided on portions on an arrow X2 direction side (first side) of the liquid crystal display portion 10. The dedicated information processing mode switches 31 are connected with the CPU 100 as shown in FIG. 2, and so formed that prescribed control is performed by the CPU 100 on the basis of a pressing operation of the dedicated information processing mode switches 31. The dedicated information processing mode switches 31 are switches having different functions such as the E mail, the video and voice chats and the IP telephone used dedicatedly in the information processing mode other than in the remote control mode for the audio apparatus (not shown). Further, the dedicated information processing mode switches 31 are provided on the surface of the frame 20 separately from the four-way movable switch 32, the decision switch 33, the remote control mode transition switch 34 and the return function switch 35, as shown in FIG. 1.

According to this embodiment, the four-way movable switch 32 is provided on an arrow X2 direction side of the dedicated information processing mode switches 31. The four-way movable switch 32 is an example of the “shared switch” or the “selection switch” in the present invention. The decision switch 33 is provided on a central portion of the four-way movable switch 32. The decision switch 33 is an example of the “shared switch” in the present invention. The four-way movable switch 32 and the decision switch 33 are connected with the CPU 100 respectively as shown in FIG. 2, and so formed that prescribed control is performed by the CPU 100 on the basis of pressing operations of the four-way movable switch 32 and the decision switch 33. Further, the four-way movable switch 32 and the decision switch 33 are formed to be usable (sharable) as the same functions in both of the remote control mode and the information processing mode respectively. More specifically, the four-way movable switch 32 is formed to select a prescribed command displayed on the liquid crystal display portion 10 or the like in both of the remote control mode and the information processing mode. The decision switch 33 is formed to decide the selected command in both of the remote control mode and the information processing mode.

According to this embodiment, the remote control mode transition switch 34 is provided on an arrow Y2 direction side of the four-way movable switch 32 as shown in FIG. 1, and has a function of switching the remote control mode and the information processing mode. The remote control mode transition switch 34 is an example of the “dedicated changeover switch” in the present invention. This remote control mode transition switch 34 is connected with the CPU 100 as shown in FIG. 2, and so formed that switching control between the information processing mode and the remote control mode is performed by the CPU 100 on the basis of a pressing operation of the remote control mode transition switch 34. Further, the remote control mode transition switch 34 is provided on the surface of the frame 20 separately from the dedicated information processing mode switches 31, the four-way movable switch 32, the decision switch 33 and the return function switch 35, as shown in FIG. 1.

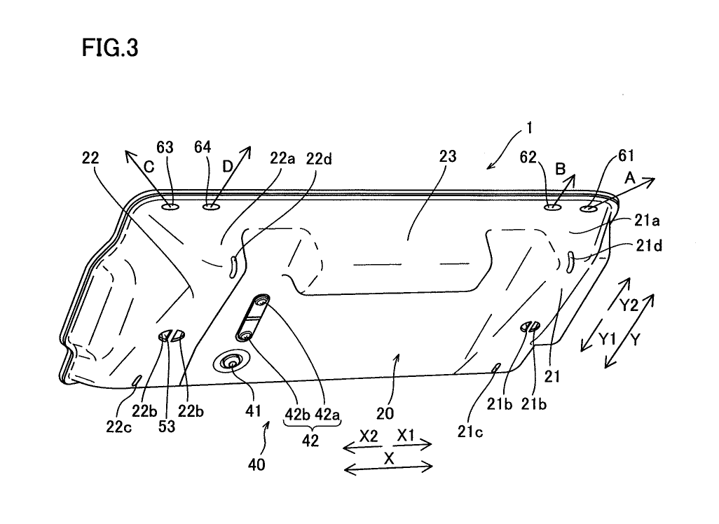

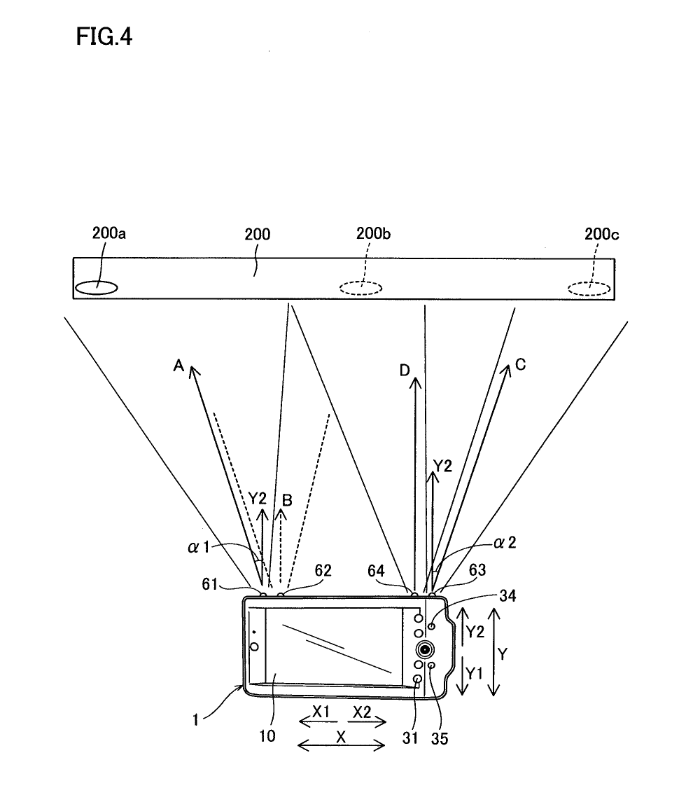

According to this embodiment, the return function switch 35 is provided on an arrow Y1 direction side of the four-way movable switch 32, and has a function of returning the portable information processing device 1 from the current state to an immediately precedent state in a remote control operation of an apparatus (television set 200 (see FIG. 4) or the like) to be remote-controlled in the remote control mode. This return function switch 35 is used only in the remote control mode, and provided dedicatedly for an operation for returning an operation screen OSD-displayed on a display portion of the apparatus (television set 200 (see FIG. 4) or the like) to be remote-controlled from the current state to the immediately precedent state. The return function switch 35 is an example of the “dedicated return function switch” in the present invention. Further, the return function switch 35 is connected with the CPU 100 as shown in FIG. 2, and so formed that control of returning the OSD-displayed operation screen to the immediately precedent state is performed by the CPU 100 on the basis of pressing of the return function switch 35. In addition, the return function switch 35 is provided on the surface of the frame 20 separately from the aforementioned dedicated information processing mode switches 31, the four-way movable switch 32, the decision switch 33 and the remote control transition switch 34, as shown in FIG. 1. The back surface-side switch portion 40 includes a power supply switch 41 and a volume switch 42, as shown in FIG. 3. The volume switch 42 is an example of the “sound control switch” in the present invention. The power supply switch 41 and the volume switch 42 are connected with the CPU 100 as shown in FIG. 2, and so formed that power supply control and volume control are performed by the CPU 100 on the basis of pressing of the power supply switch 41 and the volume switch 42. Further, the power supply switch 41 and the volume switch 42 are provided on the surface of the frame 20 opposite (rear surface side) to the surface provided with the return function switch 35, the four-way movable switch 32 and the decision switch 33. The power supply switch 41 is formed to be capable of ON- and OFF-operations of a main power supply and screen display by being pressed, as shown in FIG. 3. More specifically, the power supply switch 41 is so formed that control of turning on or off the main power supply for the portable information processing device 1 is performed by the CPU 100 (see FIG. 2) in a case where the power supply switch 41 is pressed (a case where the same is long-pressed) for a time longer than a prescribed time. Further, the power supply switch 41 is so formed that control for switching screen display on the liquid crystal display portion 10 to ON or OFF is performed by the CPU 100 in a case where the power supply switch 41 is pressed (a case where the same is short-pressed) for a time shorter than the prescribed time. The power supply switch 41 has a projectional height smaller than the projectional heights of protrusions 21 and 22.

The volume switch 42 is provided on an arrow Y2 direction side of the power supply switch 41, and formed to be capable of performing an operation of controlling the magnitudes of sounds output from a speaker 53 or the like described later. The volume switch 42 is a seesaw switch, and has a first switch portion 42a and a second switch portion 42b. The volume switch 42 is so formed that control of increasing the volume is performed by the CPU 100 (see FIG. 2) by pressing one of the first switch portion 42a and the second switch portion 42b and control of decreasing the volume is performed by the CPU 100 by pressing the other one of the first switch portion 42a and the second switch portion 42b. Further, the volume switch 42 is formed to raise/lower a volume output from an earphone (not shown) or a headphone (not shown) in a case where the earphone (not shown) or the headphone (not shown) is connected to a voice cable connection portion 94 (see FIG. 12) described later.

As shown in FIG. 1, a camera unit 51 is set on the surface of the frame 20 on a side portion of a side end portion on an arrow X1 direction side (second side) in the longitudinal direction (direction X) of the liquid crystal display portion 10. The camera unit 51 is an example of the “camera portion” in the present invention. This camera unit 51 is connected with the CPU 100 as shown in FIG. 2, and formed to be controlled by the CPU 100 on the basis of an operation or the like of the user. Further, the camera unit 51 has a function of inputting an image at a time of the video chat in a case where the user uses the portable information processing device 1 in the state grasped by the user, for example. In addition, the camera unit 51 has a function of a surveillance camera and a sensor or the like sensing brightness in the state (state of FIGS. 12 and 13) standing up the frame 20 and the liquid crystal display portion 10.

As shown in FIG. 1, a microphone unit 52 is set on a side portion on an arrow Y2 direction side (arrow Y2 direction side in the short-side direction (direction Y) of the frame 20) of the camera unit 51. This microphone unit 52 is connected with the CPU 100 as shown in FIG. 2, and so formed that control of converting a sound to a sound signal or the like is performed by the CPU 100 on the basis of a sound input. Further, the microphone unit 52 has a function of inputting sounds in a voice chat, a video chat and an IP telephone, for example. In addition, the microphone unit 52 inputs a sound in a voice memo, and also has a function as a sensor detecting an abnormal sound when the user uses the portable information processing device 1 as a monitor.

As shown in FIG. 3, the speaker 53 (see FIG. 2) is built in the back surface side of the frame 20. This speaker 53 is connected with the CPU 100 as shown in FIG. 2, and formed to be controlled by the CPU 100. Further, the speaker 53 has a function of outputting various warning sounds, various sound files and sounds in music replay, video replay, a voice chat, a video chat and Internet radio replay etc.

According to this embodiment, near infrared LEDs 61, 62, 63 and 64 for emitting near infrared rays including remote control operation signals to the apparatus (television set 200 (see FIG. 4) or the like, for example) to be remote-controlled in the remote control mode are provided on end surfaces 21a and 22a on an arrow Y2 direction side of the frame 20, as shown in FIG. 3. The near infrared LED 61 is an example of the “second infrared emission portion” or the “left infrared emission portion” in the present invention, and the near infrared LED 63 is an example of the “second infrared emission portion” or the “right infrared emission portion” in the present invention. The near infrared LED 62 is an example of the “third infrared emission portion” in the present invention, and the near infrared LED 64 is an example of the “first infrared emission portion” in the present invention. The near infrared LEDs 61 to 64 are connected with the CPU 100 through an LED driver 65 as shown in FIG. 2, and formed to be controlled by the CPU 100 through the LED driver 65. The near infrared LEDs 61 and 62 are provided on the end surface 21a on the arrow Y2 direction side which is a first end portion side where the thickness of the protrusion 21 described later is large.

The near infrared LED 61 is provided in the vicinity of an end portion on an arrow X1 direction side (left side) of the end surface 21a, as shown in FIG. 3. Further, the near infrared LED 61 is formed to emit the near infrared rays including the remote control operation signal while centering on a direction (arrow A direction in FIG. 4) inclined by a prescribed angle α1 in an arrow X1 direction (left direction) with respect to the direct-front direction (arrow Y2 direction) in plan view, as shown in FIG. 4. In addition, the near infrared LED 61 is formed to emit the near infrared rays including the remote control operation signal substantially parallelly to a placing surface P as viewed from a side portion (arrow X1 direction side), as shown in FIG. 5. In other words, the near infrared LED 61 is provided for emitting the near infrared rays including the remote control operation signal to the television set 200 (apparatus to be remote-controlled) or the like in a state (see FIG. 5) arranging the frame 20 and the liquid crystal display portion 10 to lay down the same with respect to the placing surface P.

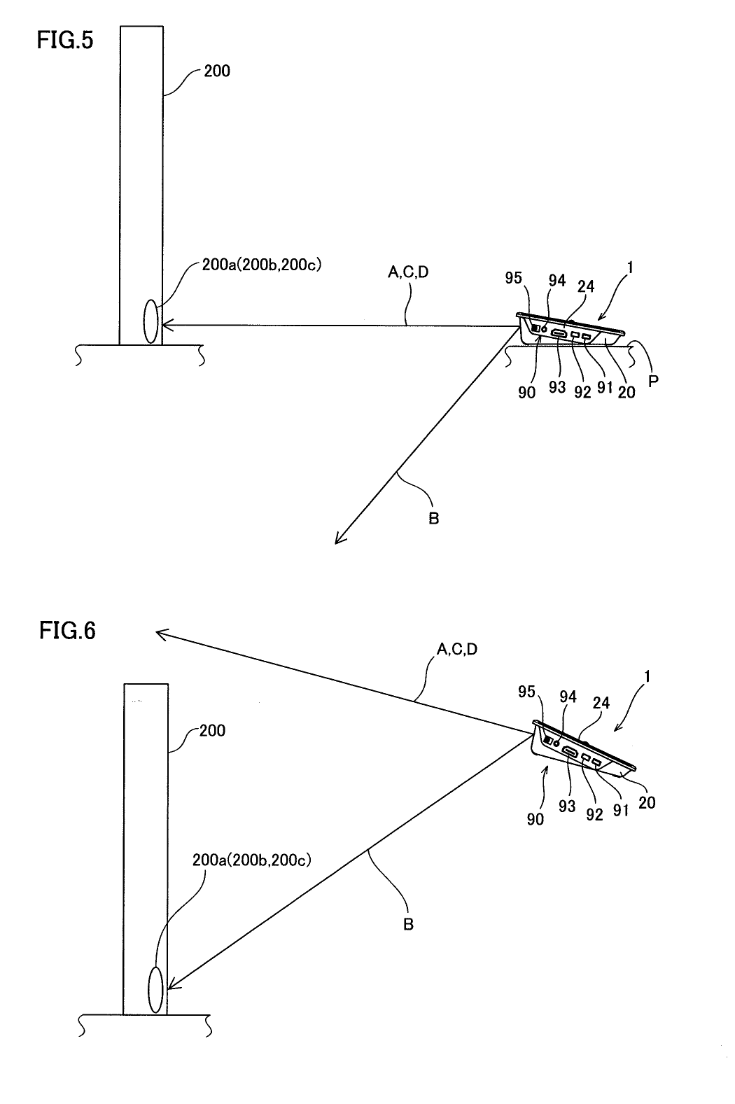

The near infrared LED 62 is provided on an arrow X2 direction side of the near infrared LED 61 on the end surface 21a, as shown in FIG. 3. Further, the near infrared LED 62 is formed to emit the near infrared rays including the remote control operation signal while centering on the direct-front direction (arrow Y2 direction (arrow B direction in FIG. 4)) in plan view, as shown in FIG. 4. In addition, the near infrared LED 62 is formed to emit the near infrared rays including the remote control operation signal toward the placing surface P side (obliquely downward) as viewed from a side portion (arrow X1 direction side), as shown in FIG. 5. In other words, the near infrared LED 62 is provided for emitting the near infrared rays including the remote control operation signal toward an oblique lower side (apparatus (television set 200 or the like) to be remote-controlled) with respect to the directions where the near infrared rays are emitted from the near infrared LEDs 61, 63 and 64 in a state where the portable information processing device 1 is so grasped by the user that the longitudinal direction (direction X) of the liquid crystal display portion 10 is laterally directed, as shown in FIG. 6.

According to this embodiment, the near infrared LEDs 63 and 64 are provided on the end surface 22a on the arrow Y2 direction side which is the first end portion side where the thickness of the protrusion 22 described later is large, as shown in FIG. 3.

The near infrared LED 63 is provided in the vicinity of an end portion on an arrow X2 direction side (right side) of the end surface 22a. Further, the near infrared LED 63 is formed to emit the near infrared rays including the remote control operation signal while centering on a direction (arrow C direction in FIG. 4) inclined by a prescribed angle α2 in an arrow X2 direction (right direction) with respect to the direct-front direction (arrow Y2 direction) in plan view, as shown in FIG. 4. In addition, the near infrared LED 63 is formed to emit the near infrared rays including the remote control operation signal substantially parallelly to the placing surface P as viewed from a side portion (arrow X2 direction side), as shown in FIG. 5. In other words, the near infrared LED 63 is provided for emitting the near infrared rays including the remote control operation signal to the apparatus (television set 200 or the like) to be remote-controlled in the state arranging the frame 20 and the liquid crystal display portion 10 to lay down the same with respect to the placing surface P, as shown in FIG. 5.

The near infrared LED 64 is provided on an arrow X1 direction side of the near infrared LED 63 on the end surface 22a, as shown in FIG. 3. Further, the near infrared LED 64 is formed to emit the near infrared rays including the remote control operation signal while centering on the direct-front direction (arrow Y2 direction (arrow D direction in FIG. 4)) in plan view as shown in FIG. 4, dissimilarly to the near infrared LED 63. In addition, the near infrared LED 64 is formed to emit the near infrared rays including the remote control operation signal substantially parallelly to the placing surface P as viewed from a side portion (arrow X2 direction side) similarly to the near infrared LED 63, as shown in FIG. 5. In other words, the near infrared LED 64 is provided for emitting the near infrared rays including the remote control operation signal to the apparatus (television set 200 or the like) to be remote-controlled in the state arranging the frame 20 and the liquid crystal display portion 10 to lay down the same with respect to the placing surface P, similarly to the near infrared LED 63.

The near infrared LEDs 61, 63 and 64 are formed to emit the near infrared rays including the remote control operation signals substantially parallelly to the placing surface P as viewed from the side portion (direction X side) and toward the directions (the arrow A direction and the arrow C direction) inclined by the prescribed angles α1 and α2 with respect to the direct-front direction (arrow D direction) and the direct-front direction (arrow Y2 direction) in plan view as hereinabove described, whereby it becomes possible to emit the near infrared rays including the remote control operation signals in a wide angular range, as shown in FIG. 4. In other words, it becomes possible to emit the near infrared rays including the remote control operation signals from an arrow X1 direction end portion in the width direction of the television set 200 to an arrow X2 direction end portion also in a case where the television set 200 is remote-control-operated in a state where the portable information processing device 1 is arranged in the horizontal direction in the vicinity of the television set 200 having a relatively large screen size, whereby it becomes possible for the user to perform a remote control operation with the portable information processing device 1 without caring about directivity of the emitted near infrared rays in any case such as a case where a remote control photoreceiving portion of the television set 200 is present in the vicinity (remote control photoreceiving portion 200a) of the arrow X1 direction end portion, a case where the same is present in the vicinity (remote control photoreceiving portion 200b) of a central portion in the direction X or a case where the same is present in the vicinity (remote control photoreceiving portion 200c) of the arrow X2 direction end portion.

Further, the near infrared LED 62 is formed to emit the near infrared rays including the remote control operation signal toward the placing surface P as viewed from the side portion (direction X side) and toward the direct-front direction (arrow B direction) in plan view as hereinabove described, whereby it becomes possible to emit the near infrared rays from the near infrared LED 62 toward a front portion (arrow B direction) of the user also in a case where the television set 200 is remote-control-operated in a state where the user grasps the portable information processing device 1 while laterally directing the longitudinal direction (direction X) and upwardly directing the arrow Y2 direction side, as shown in FIG. 6.

The portable information processing device 1 includes the CPU 100, a flash memory 71 and a main memory 72, as shown in FIG. 2. The CPU 100 is capable of reading programs stored in the flash memory 71 on the main memory 72 and running the same.

According to this embodiment, the CPU 100 is formed to be capable of switch-controlling the information processing mode and the remote control mode, as hereinabove described. More specifically, the CPU 100 is formed to perform switch control to the remote control mode in a case where the remote control mode transition switch 34 is turned on (pressed) by the user in the information processing mode. Further, the CPU 100 is formed to perform control so that the portable information processing device 1 operates as a remote control in the remote control mode. In addition, the CPU 100 is formed to perform switch control to the information processing mode in a case where the remote control mode transition switch 34 is turned off (pressed) by the user in the remote control mode.

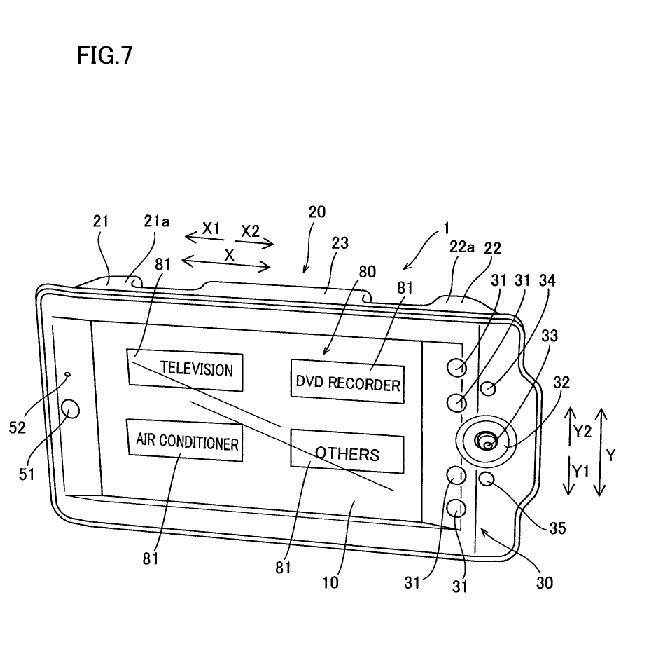

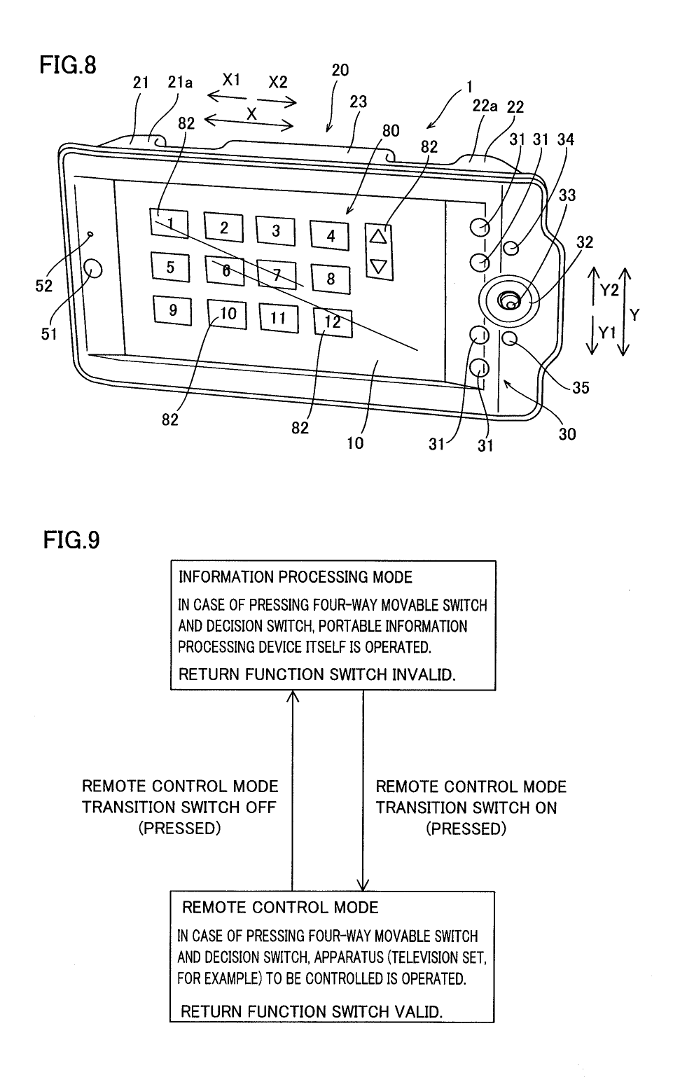

The CPU 100 is formed to control the liquid crystal display portion 10 to display a plurality of remote control operation buttons 80 (see FIGS. 7 and 8) for performing operations as the remote control in the remote control mode. These remote control operation buttons 80 include object apparatus selection buttons 81 selecting an apparatus to be controlled to be subjected to a remote control operation from among a plurality of apparatuses (the television set 200 (see FIG. 4), a DVD recorder (not shown) etc., for example) to be controlled in the remote control mode, as shown in FIG. 7. Further, the remote control operation buttons 80 include object apparatus operation buttons 82 corresponding to a selected apparatus (television set 200 (see FIG. 4), for example) to be controlled, as shown in FIG. 8. The CPU 100 is so formed, in a case where any apparatus (television set 200 (see FIG. 4), for example) to be controlled is selected by any object apparatus selection button 81 in the remote control mode, as to control the liquid crystal display portion 10 to display the object apparatus operation buttons 82 corresponding to the selected apparatus (television set 200 (see FIG. 4), for example) to be controlled.

State transition between the information processing mode and the remote control mode is now described in detail. In a case where the four-way movable switch 32 (see FIG. 1) and the decision switch 33 (see FIG. 1) are pressed by the user in the case of the information processing mode, the portable information processing device 1 itself is operated by the CPU 100 (see FIG. 2), as shown in FIG. 9. More specifically, the four-way movable switch 32 and the decision switch 33 are operated, whereby command selection and decision on an E mail, a video chat, a voice chat, an IP telephone or the like are performed. In the case of the information processing mode, not only the four-way movable switch 32 (see FIG. 1) and the decision switch 33 (see FIG. 1), but also the liquid crystal display portion 10 is subjected to a touch panel operation, whereby the portable information processing device 1 itself is operated by the CPU 100 (see FIG. 2). Thus, it becomes possible to immediately operate the portable information processing device 1 itself by simply performing the touch panel operation. In the case of the information processing mode, the return function switch 35 is controlled by the CPU 100 to be invalid.

In a case where the remote control mode transition switch 34 is turned on (pressed) by the user in the case of the information processing mode, the portable information processing device 1 is switched from the information processing mode to the remote control mode by the CPU 100. Thus, in a case where the four-way movable switch 32 and the decision switch 33 are pressed in the remote control mode, a selected apparatus (television set 200 (see FIG. 4), for example) to be controlled is operated. More specifically, the four-way movable switch 32 and the decision switch 33 are operated, whereby selection and decision of a remote control command for operating the apparatus to be controlled are performed. A signal at the time when the four-way movable switch 32 and the decision switch 33 are pressed is transmitted to the apparatus (television set 200 (see FIG. 4), for example) to be controlled through the LED driver 65 (see FIG. 2) and the near infrared LEDs 61, 62, 63 and 64 (see FIG. 2). Thus, the selected apparatus to be controlled is controlled on the basis of the transmitted signal. In the case of the remote control mode, the touch panel operation is performed not only on the four-way movable switch 32 (see FIG. 1) and the decision switch 33 (see FIG. 1) but also on the liquid crystal display portion 10, whereby the selected apparatus (television set 200 (see FIG. 4), for example) to be controlled is operated by the CPU 100. Thus, it becomes possible to immediately operate the selected apparatus to be controlled by simply performing the touch panel operation.

In the case where the portable information processing device 1 is switched from the information processing mode to the remote control mode, the return function switch 35 is validated by the CPU 100. Thus, the user so presses the return function 35 that it becomes possible to immediately return an OSD-displayed operation screen from the current state to an immediately precedent state in a case where he/she wishes to return the operation screen OSD-displayed on the display portion of the television set 200 (see FIG. 4) from the current state to the immediately precedent state.

In a case where the remote control mode transition switch 34 is turned off (pressed) by the user in the case of the remote control mode, the portable information processing device 1 is switched from the remote control mode to the information processing mode by the CPU 100. In this case, a used state in the information processing mode switched from the remote control mode is returned to the same state as the used state in the information processing mode not yet switched to the remote control mode.

A plurality of connection portions 90 are provided on the portable information processing device 1, as shown in FIG. 5. These plurality of connection portions 90 are provided on a side surface portion 24 on the arrow X1 direction side (see FIG. 1) of the frame 20. The plurality of connection portions 90 include two USB connection portions 91 and 92, an HDMI connection portion 93, the voice cable connection portion 94 and a power supply connector 95. The two USB connection portions 91 and 92, the HDMI connection portion 93 and the voice cable connection portion 94 are connected with the CPU 100, as shown in FIG. 2.

The two USB connection portions 91 and 92 are provided for connecting the portable information processing device 1 with an external apparatus (not shown) through unshown USB cables respectively. The HDMI connection portion 93 is formed to be capable of transmitting images and sound data to the television set 200 (see FIG. 4) or the like in a case where the same is connected with the television set 200 (see FIG. 4) or the like through an unshown HDMI cable. The voice cable connection portion 94 is so formed that the earphone (not shown) or the headphone (not shown) is connectable thereto. The power supply connector 95 is provided for incorporating power into the portable information processing device 1.

The structure of the frame 20 of the portable information processing device 1 is now described in detail with reference to FIGS. 1 to 3 and FIGS. 10 to 16.

The frame 20 is made of resin, as shown in FIGS. 1 and 3. A plurality of protrusions 21, 22 and 23 are integrally provided on the surface of the frame 20 opposite to the surface provided with the liquid crystal display portion 10.

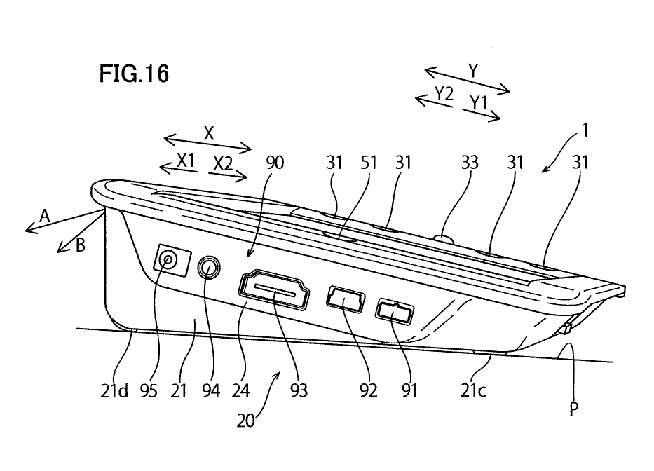

The protrusion 21 is provided in the vicinity of an end portion on an arrow X1 direction side in the longitudinal direction (direction X) of the frame 20 to extend in the short-side direction (direction Y) of the frame 20, as shown in FIG. 3. The protrusion 22 is provided in the vicinity of an end portion on an arrow X2 direction side in the longitudinal direction (direction X) of the frame 20 to extend in the short-side direction (direction Y) of the frame 20. In other words, the protrusions 21 and 22 are provided in the vicinity of both end portions in the longitudinal direction (direction X) of the frame 20, and constitute grasp portions for grasping the frame 20 with the hands of the user in a state laterally directing the longitudinal direction (direction X) of the frame 20 and the liquid crystal display portion 10. As shown in FIGS. 14 and 16, the protrusions 21 and 22 are so formed that the thicknesses gradually increase from end portion sides in the arrow Y1 direction of the frame 20 toward end portion sides in the arrow Y2 direction respectively.

The protrusions 21 and 22 are so formed in the aforementioned manner that the frame 20 is supportable with the protrusion 21 and the protrusion 22 in the state standing up the frame 20 and the liquid crystal display portion 10, as shown in FIGS. 12 and 13. In this case, a display on the liquid crystal display portion 10 is so displayed that the arrow Y2 direction side is the lower direction. As shown in FIGS. 14 to 16, the protrusions 21 and 22 are capable of supporting the frame 20 respectively in a state inclining the frame 20 and the liquid crystal display portion 10 by a prescribed angle with respect to the placing surface P in the state laying down the frame 20 and liquid crystal display portion 10. In this case, a display on the liquid crystal display portion 10 is so displayed that the arrow Y1 direction side is the lower direction.

Further, the protrusions 21 and 22 are so formed in the aforementioned manner that the protrusions 21 and 22 are graspable with both hands while laterally directing the longitudinal direction (direction X) of the frame 20 and the liquid crystal display portion 10, as shown in FIG. 10. In this case, the protrusion 21 is grasped in a state where the forefinger or the like of the right hand of the user is attached thereto, while the protrusion 22 is grasped in a state where the forefinger or the like of the left hand of the user is attached thereto. As shown in FIG. 11, the protrusions 21 and 22 are graspable with one hand while laterally directing the short-side direction (direction Y) of the frame 20 and the liquid crystal display portion 10. In this case, the protrusion 22 is grasped in a state where the middle finger of the user is attached to a line (broken line portion in FIG. 11) on an arrow X1 direction side of the protrusion 22.

The protrusion 23 is provided in the vicinity of an arrow Y2 direction end portion in the short-side direction (direction Y) of the frame 20 between the protrusions 21 and 22, as shown in FIG. 3. The protrusion 23 protrudes in a direction similar to the directions where the protrusions 21 and 22 protrude, independently of the protrusions 21 and 22. A chargeable secondary battery for supplying power to the portable information processing device 1 is built (stored) in this protrusion 23. A lithium ion battery, a nickel-hydrogen battery or a lithium polymer battery, for example, is used for the secondary battery stored in the protrusion 23.

Openings 21b and 22b are provided on the protrusions 21 and 22 respectively. These openings 21b and 22b are provided for externally outputting sounds output from the speaker 53 respectively.

Projecting portions 21c and 22c are provided in the vicinity of end portions on the arrow Y1 direction sides of the respective ones of the protrusions 21 and 22 integrally with the frame 20. Further, projecting portions 21d and 22d are provided in the vicinity of end portions on the arrow Y2 direction sides of the protrusions 21 and 22 integrally with the frame 20. These projecting portions 21c and 22c and the projecting portions 21d and 22d come into point contact with the placing surface P respectively, whereby it is possible to stably place the frame 20 on the placing surface P.

According to this embodiment, as hereinabove described, the return function switch 35 for returning the portable information processing device 1 to the immediately precedent operation in the remote control operation of the apparatus (television set 200, for example) to be controlled in the remote control mode is provided on the surface of the frame 20 so that the switch of the return function having relatively high utilization frequency in the remote control mode is provided dedicatedly to the return function, whereby the user can easily grasp the position and the function of the return function switch 35. Thus, the user can easily enter the return function switch 35 in a case where he/she wishes to return the portable information processing device 1 to the immediately precedent operation in the remote control operation of the apparatus to be controlled in the remote control mode. Consequently, convenience at the time of using the portable information processing device 1 in the remote control mode can be improved. Further, the four-way movable switch 32 and the decision switch 33 (shared switch) sharable in the remote control mode and in the information processing mode are provided on the surface of the frame 20 separately from the return function switch 35, whereby the number of switches provided on the surface of the frame 20 can be reduced as compared with a case of providing all of switches used in the remote control mode separately from switches used in the information processing mode.

According to this embodiment, as hereinabove described, the four-way movable switch 32 (selection switch) having the function of selecting selection items in both of the remote control mode and the information processing mode and the decision switch 33 having the function of deciding the selected selection items in both of the remote control mode and the information processing mode are provided, whereby the user can easily grasp the positions and the functions of the four-way movable switch (selection switch) and the decision switch 33 in either case of the remote control mode and the information processing mode. Thus, the number of switches provided on the surface of the frame 20 can be reduced while improving convenience at the time of using the portable information processing device 1 in the remote control mode.

According to this embodiment, as hereinabove described, the dedicated information processing mode switches 31 used in the information processing mode are provided on the surface of the frame 20 separately from the return function switch 35, the four-way movable switch 32 and the decision switch 33 so that the user can easily grasp the positions and the functions of the dedicated information processing mode switches 31 in the information processing mode, whereby he/she can easily enter the dedicated information processing mode switches 31. Consequently, convenience at the time of using the portable information processing device 1 in the information processing mode can be improved.

According to this embodiment, as hereinabove described, the remote control mode transition switch 34 for switching the information processing mode and the remote control mode is provided on the surface of the frame 20 separately from the return function switch 35, the four-way movable switch 32 and the decision switch 33 while the CPU 100 is formed to control the portable information processing device 1 to operate as the remote control on the basis of that the remote control mode transition switch 34 has entered an ON state, whereby the user can immediately switch the portable information processing device 1 to the remote control mode by turning on the remote control mode transition switch 34 in a case where he/she wishes to use the portable information processing device 1 as the remote control, dissimilarly to a case of switching the portable information processing device 1 to the remote control mode by operating a menu screen. Thus, the convenience at the time of using the portable information processing device 1 in the remote control mode can be further improved.

According to this embodiment, as hereinabove described, the CPU 100 controls the liquid crystal display portion 10 to display the plurality of remote control operation buttons 80 for performing the operation as the remote control in the remote control mode so that the number of switches arranged on the surface of the frame 20 can be reduced, whereby the plurality of remote control operation buttons 80 are so displayed on the liquid crystal display portion 10 that the portable information processing device 1 can be inhibited from size increase.

According to this embodiment, as hereinabove described, the CPU 100 controls the liquid crystal display portion 10 to display any object apparatus operation button 82 corresponding to a selected apparatus to be controlled when the apparatus to be controlled is selected by any object apparatus selection button 81 in the remote control mode, whereby the portable information processing device 1 can be used as a remote control corresponding to a plurality of object apparatuses.

According to this embodiment, as hereinabove described, the CPU 100 controls the portable information processing device 1 to be capable of performing a remote control operation by employing both of the four-way movable switch 32 as well as the decision switch 33 and the remote control operation buttons 80 also in a case where the remote control operation buttons 80 are displayed on the liquid crystal display portion 10 in the remote control mode so that the user can perform the remote control operation by selecting either the four-way movable switch 32 as well as the decision switch 33 or the remote control operation buttons 80 in response to the use situation of the user, whereby convenience for the user in the remote control mode can be further improved.

According to this embodiment, as hereinabove described, the near infrared LED 64 capable of emitting the near infrared rays including the remote control operation signal to a substantially anterior direct front (arrow D direction (arrow Y2 direction)) in the state arranging the frame 20 to lay down the frame 20 and the liquid crystal display portion 10 with respect to the placing surface P and the near infrared LEDs 61 and 63 capable of emitting the near infrared rays including the remote control operation signals while inclining the near infrared rays by the prescribed angles α1 and α2 with respect to the anterior direct front (arrow Y2 direction) in plan view in the state arranging the frame 20 to lay down the frame 20 and the liquid crystal display portion 10 with respect to the placing surface P are so provided that the near infrared rays including the remote control operation signals can be emitted at wide angles in plan view due to the near infrared LEDs 61, 63 and 64, whereby the remote control photoreceiving portion (any of the remote control photoreceiving portions 200a, 200b and 200c) of the television set 200 (apparatus to be remote-controlled) can be made to receive the near infrared rays including the remote control operation signal emitted from any of the near infrared LEDs 61, 63 and 64 also in a case of arranging the frame 20 of the portable information processing device 1 to lay down the frame 20 and the liquid crystal display portion 10 with respect to the placing surface P on a position close to the television set 200 having a large-sized screen.

According to this embodiment, as hereinabove described, the near infrared LEDs 61 to 64 are provided on the first end portion side (arrow Y2 direction side) where the thicknesses of the protrusions 21 and 22 are large, whereby the near infrared LEDs 61 to 64 can emit the near infrared rays including the remote control operation signals toward the front surface side in the state laying down the frame 20 and the liquid crystal display portion 10 where the frame 20 and the liquid crystal display portion 10 are opposed to the user.

According to this embodiment, as hereinabove described, the near infrared LED 62 capable of emitting the near infrared rays including the remote control operation signal while inclining the near infrared rays by the prescribed angle obliquely downward with respect to the directions where the near infrared rays are emitted from the near infrared LEDs 61, 63 and 64 from the front end portion of the frame 20 in the state where the user manually grasps the grasp portions (protrusions 21 and 22) so that the longitudinal direction of the frame 20 and the liquid crystal display portion 10 is laterally directed so that the near infrared LED 62 can emit the near infrared rays including the remote control operation signal while inclining the near infrared rays by the prescribed angle obliquely downward also in the case where the user manually grasps the grasp portions (protrusions 21 and 22) so that the longitudinal direction of the frame 20 and the liquid crystal display portion 10 is laterally directed, whereby any of the remote control photoreceiving portions 200a, 200b and 200c of the television set 200 can be made to receive the near infrared rays including the remote control operation signal also in a case where height positions of the remote control photoreceiving portions 200a, 200b and 200c of the television set 200 and the portable information processing device 1 are different from each other.

According to this embodiment, as hereinabove described, the plurality of projecting portions 21c, 22c, 21d and 22d bringing the frame 20 into point contact with the placing surface P in the state laying down the frame 20 and the liquid crystal display portion 10 are provided on the protrusions 21 and 22, whereby the frame 20 can be inhibited from backlashing on the placing surface P due to the point contact, as compared with a case where the protrusions 21 and 22 and the placing surface P are in surface contact with each other.

According to this embodiment, as hereinabove described, the return function switch 35, the four-way movable switch 32 and the decision switch 33 are provided on the first side (arrow X2 direction side) of the liquid crystal display portion 10 on the surface in the longitudinal direction (direction X) of the frame 20 respectively, whereby the user can easily operate all of the return function switch 35, the four-way movable switch 32 and the decision switch 33 with only the hand on the first side (arrow X2 direction side).

According to this embodiment, as hereinabove described, the camera unit 51 is provided on the second side (arrow X1 direction side) of the liquid crystal display portion 10 on the surface in the longitudinal direction (direction X) of the frame 20, whereby the hand of the user operating the return function switch 35, the four-way movable switch 32 and the decision switch 33 can be inhibited from blocking the field of view of the camera unit 51 when the user operates the return function switch 35, the four-way movable switch 32 and the decision switch 33 provided on the first side (arrow X2 direction side) of the liquid crystal display portion 10 on the surface in the longitudinal direction (direction X) of the frame 20.

According to this embodiment, as hereinabove described, the power supply switch 41 is provided on the surface of the frame 20 opposite to the surface provided with the return function switch 35, the four-way movable switch 32 and the decision switch 33 so that the power supply switch 41 is provided on the surface opposite to the side where the return function switch 35, the four-way movable switch 32 and the decision switch 33 frequently operated in use of the device are arranged, whereby the power supply switch 41 can be inhibited from being erroneously operated by the user in use of the device. According to this embodiment, as hereinabove described, the power supply switch 41 is formed to have the projectional height smaller than the projectional heights of the protrusions 21 and 22 so that the power supply switch 41 does not come into contact with the placing surface P also in a case of placing the frame 20 on the placing surface P in a state grounding the protrusions 21 and 22 on the placing surface P, whereby the power supply switch 41 can be inhibited from being erroneously operated.

According to this embodiment, as hereinabove described, the power supply switch 41 is formed to switch the screen display with respect to the liquid crystal display portion 10 to ON or OFF in a case where the power supply switch 41 is pressed and formed to switch the main power supply to ON or OFF in a case where the power supply switch 41 is pressed for a longer time than the time when the same is pressed at the time of switching the screen display with respect to the liquid crystal display portion 10 to ON or OFF so that the user can perform not only switching of ON or OFF of the main power supply but also switching of ON or OFF of the screen display with respect to the liquid crystal display portion 10 by employing the power supply switch 41, whereby the number of switches provided on the surface of the frame 20 can be reduced.

According to this embodiment, as hereinabove described, the volume switch 42 capable of the operation of controlling the magnitude of the output sound is provided on the surface of the housing opposite to the surface provided with the return function switch 35, the four-way movable switch 32 and the decision switch 33 so that the volume switch 42 is provided on the surface opposite to the side where the return function switch 35, the four-way movable switch 32 and the decision switch 33 frequently used in use of the device are arranged, whereby the volume switch 42 can be inhibited from being erroneously operated by the user in use of the device.

According to this embodiment, as hereinabove described, the CPU 100 invalidates the return function switch 35 in the information processing mode, whereby the user can use the return function switch 35 reliably only in the remote control mode.

The embodiment disclosed this time must be considered as illustrative in all points and not restrictive. The range of the present invention is shown not by the above description of the embodiment but by the scope of claims for patent, and all modifications within the meaning and range equivalent to the scope of claims for patent are further included.

For example, while the example of providing the four-way movable switch and the decision switch as the examples of the switch sharable in both of the information processing mode and the remote control mode has been shown in the aforementioned embodiment, the present invention is not restricted to this. Only either one of the four-way movable switch and the decision switch may be employed as the switch shared in both of the information processing mode and the remote control mode, or not only the four-way movable switch and the decision switch but also switches other than the four-way movable switch and the decision switch may be rendered sharable in both of the information processing mode and the remote control mode.

While the example of providing one remote control mode transition switch switching the information processing mode and the remote control mode has been shown in the aforementioned embodiment, the present invention is not restricted to this. A plurality of remote control mode transition switches may be provided. In this case, the remote control mode transition switches are preferably individually provided every apparatus to be remote-controlled, by providing a remote control mode transition switch dedicated to a television, a remote control mode transition switch dedicated to a DVD recorder and the like.

While the example of arranging the near infrared LEDs along the longitudinal direction of the frame has been shown in the aforementioned embodiment, the present invention is not restricted to this. The near infrared LEDs may be arranged not only along the longitudinal direction of the frame, but also along the short-side direction of the frame, or the near infrared LEDs may be arranged only along the short-side direction of the frame.

While the example of remote-controlling the apparatus to be controlled by emitting the near infrared rays including the remote control operation signals to the apparatus to be controlled in the remote control mode has been shown in the aforementioned embodiment, the present invention is not restricted to this. For example, the apparatus to be controlled may be remote-controlled by employing a wireless communication standard such as Bluetooth (registered trademark) or Zigbee (registered trademark).

While the example of forming the near infrared LED 62 to emit the near infrared rays including the remote control operation signal obliquely downward with respect to the directions where the near infrared rays are emitted from the near infrared LEDs 61, 63 and 64 has been shown in the aforementioned embodiment, the present invention is not restricted to this. According to the present invention, the near infrared LED 62 may be formed to emit the near infrared rays including the remote control operation signal obliquely upward with respect to the directions where the near infrared rays are emitted from the near infrared LEDs 61, 63 and 64.

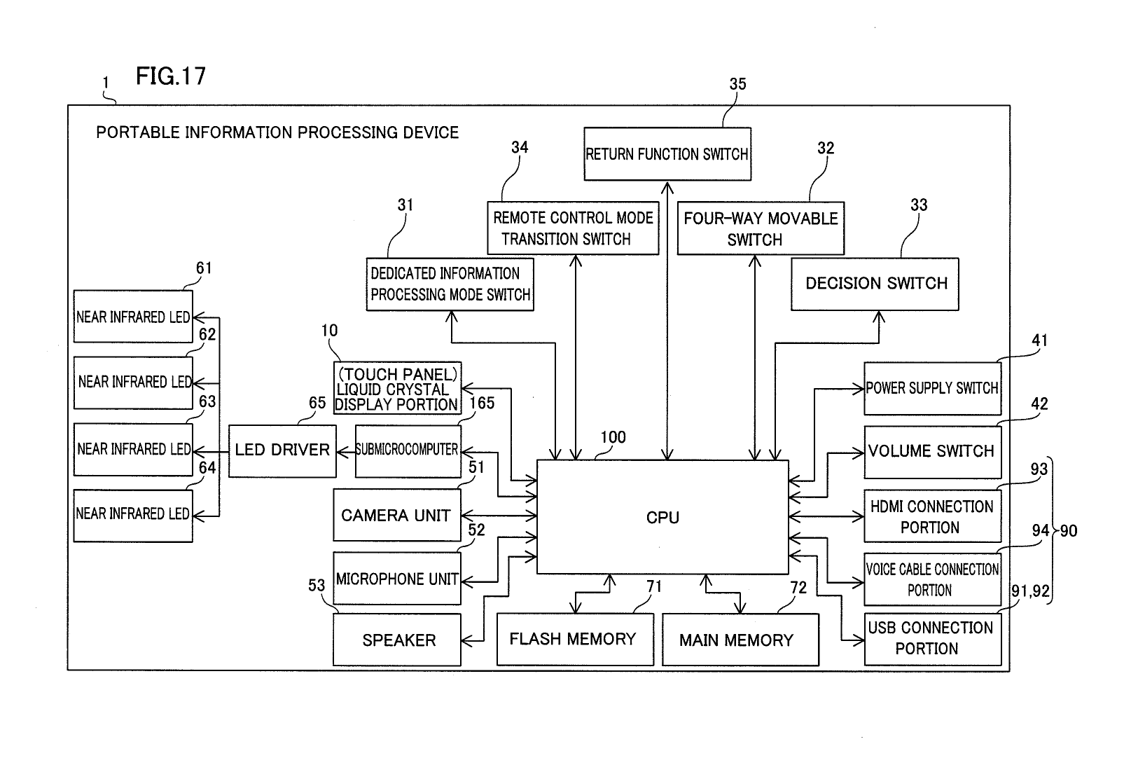

While the example of forming the portable information processing device to control the near infrared LEDS with the CPU has been shown in the aforementioned embodiment, the present invention is not restricted to this. For example, a submicrocomputer 615 may be provided between a CPU 100 and an LED driver 65 to control near infrared LEDs with the submicrocomputer 165, as in a modification shown in FIG. 17.

The submicrocomputer 165 in the aforementioned modification is provided for reducing software processing of the CPU 100, as shown in FIG. 17. More specifically, codes of infrared rays receivable by apparatuses to be controlled vary with the apparatuses to be controlled, and the submicrocomputer 165 is formed to manage the infrared code every apparatus to be controlled. In other words, the CPU 100 may not manage the infrared code every apparatus to be controlled, but may simply instruct specification of the apparatus to be controlled and a function to be operated to the submicrocomputer 165 in a remote control mode.

1. A portable information processing device (1) comprising:
a display portion (10) displaying information;
a housing (20) mounted with said display portion on a surface;
a control portion (100) capable of switch-controlling an information processing mode and a remote control mode;
a dedicated return function switch (35) provided on the surface of said housing for returning the portable information processing device to an immediately precedent operation in a remote operation of an apparatus to be controlled in the remote control mode; and
a shared switch (32, 33) provided on the surface of said housing separately from said dedicated return function switch and sharable in said remote control mode and in the information processing mode.

2. The portable information processing device according to claim 1, wherein
said shared switch includes at least one of a selection switch (32) having a function of selecting a selection item both in said remote control mode and in the information processing mode and a decision switch (33) having a function of deciding the selected selection item both in said remote control mode and in the information processing mode.

3. The portable information processing device according to claim 1, further comprising a dedicated information processing mode switch (31) provided on the surface of said housing separately from said dedicated return function switch and said shared switch to be used in the information processing mode.

4. The portable information processing device according to claim 1, further comprising a dedicated changeover switch (34) provided on the surface of said housing separately from said dedicated return function switch and said shared switch for switching said information processing mode and said remote control mode, wherein
said control portion is formed to control the portable information processing device to operate as a remote control on the basis of that said dedicated changeover switch has entered an ON state.

5. The portable information processing device according to claim 1, wherein
said display portion has a touch panel function, and
said control portion is formed to control said display portion to display a plurality of remote control operation buttons for performing an operation as a remote control in said remote control mode.

6. The portable information processing device according to claim 5, wherein
the remote control operation buttons (80) displayed on said display portion include an object apparatus selection button (81) selecting the apparatus to be controlled in said remote control mode and an object apparatus operation button (82) corresponding to said apparatus to be controlled, and
said control portion is formed to control said display portion to display said object apparatus operation button corresponding to selected said apparatus to be controlled in a case where said apparatus to be controlled is selected by said object apparatus selection button in said remote control mode.

7. The portable information processing device according to claim 5, wherein
said control portion is formed to perform control capable of performing a remote control operation with both of said shared switch and said remote control operation buttons also in a case where said remote control operation buttons are displayed on said display portion in said remote control mode.

8. The portable information processing device according to claim 1, further comprising:
a first infrared emission portion (64) capable of emitting infrared rays including a remote control operation signal to a substantially anterior direct front in a state arranging said housing to lay down said housing and said display portion with respect to a placing surface, and
a second infrared emission portion (61, 63) capable of emitting infrared rays including said remote control operation signal while inclining the infrared rays by a prescribed angle with respect to said anterior direct front in plan view in the state arranging said housing to lay down said housing and said display portion with respect to said placing surface.

9. The portable information processing device according to claim 8, wherein
said second infrared emission portion includes a right infrared emission portion (63) capable of emitting the infrared rays including said remote control operation signal while inclining the infrared rays by a first angle rightward with respect to said anterior direct front in plan view and a left infrared emission portion (61) capable of emitting the infrared rays including said remote control operation signal while inclining the infrared rays by a second angle leftward with respect to said substantially anterior direct front in plan view.

10. The portable information processing device according to claim 8, wherein
a support portion (21, 22) having a larger thickness than a second end portion side is integrally provided on at least a first end portion side on a surface of said housing opposite to the surface provided with said display portion,
said support portion is formed to be capable of supporting said housing in a state inclining said housing and said display portion by a prescribed angle with respect to the placing surface in the state laying down said housing and said display portion, and
said first infrared emission portion and said second infrared emission portion are provided on the first end portion side of said support portion.

11. The portable information processing device according to claim 8, wherein
said support portion includes grasp portions provided in the vicinity of both end portions in the longitudinal direction of said housing for manually grasping said housing in a state laterally directing the longitudinal direction of said housing and said display portion, and
the portable information processing device further comprises a third infrared emission portion (62) capable of emitting the infrared rays including said remote control operation signal while inclining the infrared rays by a third angle obliquely downward or obliquely upward with respect to a direction where the infrared rays including the remote control operation signal are emitted from said first infrared emission portion and said second infrared emission portion from a front end portion of said housing in a state manually grasping said grasp portions so that the longitudinal direction of said housing and said display portion is laterally directed.

12. The portable information processing device according to claim 10, wherein
a plurality of projecting portions (21c, 21d, 22c, 22d) bringing said housing into point contact with the placing surface in the state laying down said housing and said display portion are provided on said support portion.

13. The portable information processing device according to claim 1, wherein
said dedicated return function switch and said shared switch are provided on a first side of said display portion on the surface in the longitudinal direction of said housing respectively.

14. The portable information processing device according to claim 13, further comprising a camera portion (51) provided on a second side of said display portion on the surface in the longitudinal direction of said housing.

15. The portable information processing device according to claim 1, further comprising a power supply switch (41) provided on a surface of said housing opposite to the surface provided with said dedicated return function switch and said shared switch.

16. The portable information processing device according to claim 15, wherein
a support portion having a larger thickness than a second end portion side is integrally provided on at least a first end portion side on a surface of said housing opposite to the surface provided with said display portion, and
said power supply switch has a projectional height smaller than the projectional height of said support portion.

17. The portable information processing device according to claim 15, wherein
said power supply switch is formed to switch a screen display with respect to said display portion to ON or OFF in a case where said power supply switch is pressed, and formed to switch said main power supply to ON or OFF in a case where said power supply switch is pressed for a time longer than the time for pressing the power supply switch when switching the screen display with respect to said display portion to ON or OFF.

18. The portable information processing device according to claim 1, further comprising a sound control switch (42) provided on a surface of said housing opposite to the surface provided with said dedicated return function switch and said shared switch and capable of an operation of controlling the magnitude of an output sound.

19. The portable information processing device according to claim 1, wherein
said control portion is formed to perform control of invalidating said dedicated return function switch in said information processing mode.
